(19) United States
(12) Patent Application Publication
(10) Pub. No.: US 2022/0185040 A1
(43) Pub. Date: Jun. 16, 2022

(54) Apparatus for wireless measurement of air pressure via a valve and method for doing the same

(71) Applicant: Christopher Scott Larsen, Plymouth, MN (US)

(72) Inventor: Christopher Scott Larsen, Plymouth, MN (US)

(21) Appl. No.: 17/497,930

(22) Filed: Oct. 9, 2021

Related U.S. Application Data
(63) Continuation-in-part of application No. 16/278,684, filed on Feb. 18, 2019, now Pat. No. 11,247,515.
Application No. 16/278,684 is a continuation-in-part of application No. 15/360,968, filed on Nov. 23, 2016, now Pat. No. 10,365,176.
(60) Provisional application No. 63/105,838, filed on Oct. 26, 2020.

(51) Int. Cl. B60C 23/04

(52) U.S. Cl. CPC B60C 23/0479; B60C 23/0415; B60C 23/0494

(57) ABSTRACT

A tire parameter measurement method, device, and system of using the same are described herein. One method includes a tire air valve extension assembly with an integrated mounted pressure sensor apparatus, measuring pressure values, associating the sensor to an identification reader to receive the pressure values from the pressure sensor, and notifying a user of the measured pressure.

### RELATED APPLICATIONS

This application is a continuation of, and claims priority to U.S. patent application Ser. No. 16/278,684, filed Feb. 18, 2019 (entitled Apparatus for wheel-mounted wireless measurement of tire pressure and method for doing the same); which claims benefit of U.S. patent application Ser. No. 15/360,968 filed Nov. 23, 2016 (now U.S. Pat. No. 10,365,176, entitled WIRELESS MEASUREMENT OF INFLATABLE PRESSURE). The disclosures of the aforementioned prior applications are hereby incorporated by reference.

### TECHNICAL FIELD

The present disclosure relates to a method of measuring, recording, and tracking pressure and other parameters in an inflatable tire, and devices and systems of using the same.

### BACKGROUND

Previous approaches to wirelessly measure pressure inside an inflatable device such as a tire generally require a battery to power a wireless transceiver mounted to the wheel. The battery has a finite useable life and must eventually be replaced.

### SUMMARY

A tire parameter measurement method, device, and system of using the same are described herein. A sensor apparatus may be mounted to a wheel that maintains a gas pressure within an inflatable tire. The sensor apparatus may comprise a sensor transducer, a sensor apparatus antenna for wireless communication to an external reader device, and a control circuit configured to interpret queries from the external reader device, communicate with the sensor transducer and respond to the external reader device with data from the sensor transducer. The wireless communication between the sensor apparatus and the external reader device may be NFC or UHF RFID. The wireless communications may also be encrypted. The sensor apparatus may obtain all necessary power from the external reader device. The sensor apparatus may also contain a unique identification code. The external reader device may also include a pressure transducer such that the external reader device may subtract its ambient pressure from the pressure measured by the sensor apparatus in order to calculate a gauge pressure of the tire.

A sensor transducer capable of converting a measured quantity into a sensible reading may reside inside the tire. The sensor transducer may measure a gas pressure inside the tire.

A sensor transducer capable of converting a measured quantity into a sensible reading may reside on or in a valve stem of the tire. The sensor transducer may access the pressure inside the tire via a hole in the valve stem to measure a gas pressure inside the tire.

A sensor transducer capable of converting a measured quantity into a sensible reading may reside on or in a valve stem extension that is coupled to the valve stem of the tire. The sensor transducer may access the pressure inside the tire via a hole in the valve stem extension to measure a gas pressure inside the tire.

A sensor transducer capable of converting a measured quantity into a sensible reading may reside on or in a valve stem cap that is coupled to the valve stem of the tire. The sensor transducer may access the pressure inside the tire via a hole in the valve stem cap to measure a gas pressure inside the tire.

A sensor apparatus antenna may reside inside the tire and wheel assembly. The sensor apparatus antenna may also reside outside the tire and wheel assembly if a hole in the wheel or tire assembly allows the sensor transducer to access the pressure inside the tire. The slot or hole may be sealed with a patch or plug. The patch or plug may be a part of the sensor apparatus. The hole through which the antenna and sensor transducer are coupled may be the same hole where the valve stem used to inflate the tire passes through the wheel. The antenna may be held away from the wheel by a spacer that is nonconductive or RF absorbing. The spacer may allow better electromagnetic coupling between the external reader device and the sensor apparatus antenna.

A sensor apparatus antenna may reside on or in an air valve assembly, air valve extension, or valve stem cap. The sensor transducer may access the pressure inside the tire via a hole in the valve stem, air valve extension or valve stem cap, and the sensor transducer may be electrically coupled to the control circuit and/or sensor apparatus antenna so that it may be powered by electromagnetic energy harvested from the external reader device by the sensor apparatus antenna and/or control circuit.

Also described is a system for measuring parameters inside a tire, the system comprising a tire and wheel assembly that maintains a gas pressure, a sensor apparatus for measuring parameters within the tire and wheel assembly, and an external reader device external to tire and wheel assembly that communicates with the sensor apparatus. The sensor apparatus may measure a gas pressure within the tire and wheel assembly. The communications between the sensor apparatus and external reader device may be encrypted. The sensor apparatus may also obtain all required power for measurement and communication from the external reader device.

Also described is a method for testing a pressure, comprising a tire and wheel assembly, a sensor apparatus, measuring parameters within the tire and wheel assembly using the sensor apparatus, and wirelessly communicating these measured parameters to an external reader device to notify the user of pressure conditions inside the tire and wheel assembly. The method may identify a particular tire and wheel assembly using a unique identifier within the sensor apparatus. The method may also allow for the external reader device to provide power for the sensor apparatus to measure parameters and communicate results.

Advantages of the embodiments in this disclosure over previous approaches include the ability to track or log measured values, the ability to confirm that a user has physically viewed the tire by being proximate to it, and the ability to track test results to monitor for slow leaks or for user compliance with required test intervals

### BRIEF DESCRIPTION OF THE DRAWINGS

FIG. 1 illustrates a tire and wheel assembly and includes an air valve assembly through which air may be added to the tire with a pump or removed from the tire by depressing a valve core pin.

FIG. 2 illustrates a magnified portion of the valve section of the tire and wheel assembly.

FIG. 3 is an illustration of the cross section of a bike wheel in accordance with some embodiments.

FIG. 4 illustrates a type of air valve assembly in accordance with some embodiments.

FIG. 5 illustrates a type of air valve assembly with a removable valve core assembly in accordance with some embodiments.

FIG. 6A and FIG. 6B illustrate a valve core assembly in accordance with some embodiments of the present disclosure.

FIG. 7 illustrates an air valve assembly with an air valve extension in accordance with an embodiment of the present disclosure.

FIG. 8 illustrates an air valve assembly with an air valve extension with holes in accordance with an embodiment of the present disclosure.

FIG. 9 illustrates an air valve extension with an integrated sensor apparatus in accordance with the present disclosure.

FIG. 10 illustrates a sensor apparatus in accordance with an embodiment of the current disclosure.

FIG. 11 illustrates an air valve assembly with an air valve extension that includes an integrated sensor apparatus that has a plastic housing surrounding it in accordance with an embodiment of the present disclosure.

FIG. 12 illustrates an air valve assembly with an integrated sensor apparatus in accordance with an embodiment of the present disclosure.

FIG. 13 illustrates an air valve assembly with integrated sensor apparatus and plastic housing in accordance with an embodiment of the present disclosure.

FIG. 14 illustrates a vehicle tire and wheel assembly in accordance with some embodiments.

FIG. 15 illustrates a vehicle wheel cross section in accordance with some embodiments.

FIG. 16 illustrates a type of air valve assembly in accordance with some embodiments.

FIG. 17 illustrates a hidden line view of a type of air valve assembly in accordance with some embodiments.

FIG. 18 illustrates a different type of valve core in accordance with an embodiment of this disclosure.

FIGS. 19A and 19B illustrate a valve cap with integrated sensor apparatus in accordance with an embodiment of the present disclosure.

FIGS. 20A and 20B illustrate a valve cap with integrated sensor apparatus mated to an air valve assembly in accordance with an embodiment of the present disclosure.

FIG. 21 illustrates an air valve assembly with integrated sensor apparatus in accordance with an embodiment of the present disclosure.

FIG. 22 illustrates an air valve extension with integrated sensor apparatus in accordance with an embodiment of the present disclosure.

FIG. 23 illustrates an air valve extension with integrated sensor apparatus coupled to an air valve assembly in accordance with an embodiment of the present disclosure.

FIG. 24 illustrates an air valve assembly with air valve extension with integrated sensor apparatus and two valve cores in accordance with an embodiment of the current disclosure.

### DETAILED DESCRIPTION

A test method, device, and system of using the same are described herein. For example, one or more embodiments includes an inflatable tire mounted to a wheel with an air valve assembly to allow air to be added to or removed from the tire. In one or more embodiments, the air valve assembly may include a sensor apparatus capable of measuring pressure values, associating the sensor to an external reader device to transmit wireless power to the sensor apparatus, receiving the values from the sensor apparatus, and notifying a user of the measurements. In one or more embodiments an air valve extension may be fixed to an air valve assembly, the air valve extension having an integrated sensor apparatus capable of measuring pressure values, associating the sensor to an external reader device to transmit wireless power to the sensor apparatus, receiving the values from the sensor apparatus, and notifying a user of the measurements. In one or more embodiments a valve cap may be fixed to an air valve assembly, the valve cap having an integrated sensor apparatus capable of measuring pressure values, associating the sensor to an external reader device to transmit wireless power to the sensor apparatus, receiving the values from the sensor apparatus, and notifying a user of the measurements.

Testing an inflatable tire in accordance with embodiments of the present disclosure may measure and record the pressure, temperature, and/or other parameters inside the tire. As a result, the effect on pressure of changes in conditions (e.g. changing temperature) may be determined, various leaks within the inflatable tire may be detected, the measurements may be tracked, and data may be secured.

Pressure, as used herein, generally refers to gas or a substance in an inflatable tire. Pressures of interest in accordance with embodiments of the present disclosure include air, smoke, water, chemicals, as well as mixtures of these and other gas/substance forms.

While previous approaches for testing a pressure use manual gauges to break the seal of the inflatable tire, embodiments of the present disclosure may quantitatively test a pressure using a manufactured sensor apparatus. For example, a pressure sensor apparatus with continuous access to the pressure inside the tire may provide an increased accuracy reading related to the pressure, and the reading(s) may be tracked and/or recorded for record keeping purposes, and/or to monitor compliance among users, among other benefits.

The disclosed approach may be performed by any user with an appropriate wireless external reader device such as a smartphone enabled with near field communication (NFC), or such as a ultra-high frequency (UHF) radio frequency identification (RFID) reader. The system may allow for tracking, secured data to prevent data tampering, temperature compensation, and external pressure compensation, with no requirement to break the pressure seal of the inflatable tire. Individual human users may use the disclosed approach for spot checks of tire measurements when in a remote location, for example, away from their home base, company origin, or truck depot, at a remote location such as an ATV trail or bike path. In these situations, the human user may quickly check tire pressure and/or temperature without requiring an invasive pressure gauge to be attached to each separate tire in turn. The disclosed approach allows remote tire measurements without a physical connection between the external reader device and the tire itself. Drivers, riders, or other users may quickly measure the tire parameters by approaching it with the external reader device. A sensor apparatus capable of measuring pressure values internal to the tire may harvest power from the external reader device, use it to measure an internal pressure, temperature, and/or other parameter(s), and report the measured values back to the external reader device. The human user testing the tire may measure the parameters for all tires on their vehicle within several seconds.

Some organizations may require a daily check of all truck tires to ensure they are operational. The requirements may be legal, such as in the case of the US Department of Transportation requirements for over the road truck drivers, or procedural, such as in the case of a truck driver employer or fleet owner. The disclosed approach allows not only checking, but proof of compliance that each tire has been checked. The relatively short-range nature of the approach guarantees that the driver is within viewing distance of the tire, so the approach provides documentation that the human user measuring has been in near proximity to the tire, and has likely not only checked its measurements, but has also been close enough to view the tire to inspect it for physical damage. This provides a useful record of tire safety checks for confirmation of compliance with required procedures. Recordings of measurements and other data about the measurements such as time and geographic location of when each measurement was taken may be logged to an internet-connected database. This database may be used by a trucking fleet or employer to track and document whether drivers are checking all tire positions on a regular basis.

In some embodiments, the disclosed approach may be used for automated checks of tire pressure. For example, a vehicle may drive through a special lane at a truck stop, depot, or other location where fixed external reader devices power sensors internal to the tires and record measurements. In one embodiment, fixed external reader devices or their associated antennas may reside on each side of the truck wheels in each axle position. In another embodiment, there may be one fixed external reader device or antenna on each side of the truck that is able to power all wheel positions on that side of the truck. In another embodiment, there may be one reader that may read all the measurements of all wheel positions from one fixed position. In some embodiments, the truck may drive past the fixed reader(s) to position the wheel positions for the fixed reader.

In some embodiments, the disclosed approach may be used for central automatic tire pressure monitoring within the vehicle itself. In one embodiment, external reader devices or antennas may be mounted near the wheel positions of the vehicle in order to record measurements from the tires during vehicle operation. In this embodiment, the vehicle may be monitored while driving.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein may be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of pressure sensors” can refer to one or more pressure sensors.

In some embodiments, a pressure sensor can be combined to include a radio frequency identification (RFID) Integrated Circuit (IC) as a identifier. The sensor apparatus may provide a unique identifier that can be used, for example, to track (e.g., via a computing system with a database) the condition of the inflatable tire pressure over time, among other functions. The identifier can be numeric, alphanumeric, identified by one or more symbols, or other suitable identification mechanisms that can allow one to be distinguished from another. This identifier can be used to, for example, track the dates on which a particular inflatable tire has had its pressure measured, the pressure values on those dates, the owner of the inflatable tire, and other useful information about the inflatable tire.

In some embodiments, the sensor apparatus may have user-writeable memory that allows the user to record certain values to the sensor apparatus itself. The user-writeable memory may be used to, for example, record a serial number for the inflatable, to tie the inflatable serial number to the unique identifier of the sensor apparatus, or to record the number of times the sensor apparatus has been read back to the sensor apparatus. Recording the number of times the sensor apparatus has been read may be useful in developing an expiration model for the sensor such that it may only be read a certain number of times.

In some embodiments, a sensor apparatus may be mounted within the inflatable tire to the wheel on which the tire is mounted such that the sensor may assess the air pressure changes (e.g., pressure leakage) inside the inflatable tire.

In some embodiments, the sensor may be molded within the body of the inflatable tire (e.g., on or near an inside surface of the inflatable tire). For example, the sensor may be molded into the rubber used to mold the body of the tire. In some embodiments, the sensor may be adhesively applied to an inside surface of the inflatable tire. In some embodiments, a small hole may be formed in the inflatable tire and the pressure sensor circuit assembly may be used as a patch for that hole. The pressure sensor transducer on the circuit assembly may be situated directly over the hole to allow pressure measurement.

In some embodiments, the sensor may be a patch adhered to the inflatable tire, for example with an adhesive. The sensor may act as a patch to seal the gas housing from leaking through the hole provided for the pressure sensor. In this way, the sensor may be applied to existing tires without removing the tire from the wheel. Only a small hole needs to be created, which the sensor may patch to prevent excessive leaking. When the sensor is applied, the pressure sensor transducer should be aligned to the hole to ensure the pressure present at the pressure sensor transducer is equal to the pressure in the gas housing.

In some embodiments, the sensors do not need to be active at all times, but only when pressure testing takes place. As such, these types of sensors may be low power sensors that may, for example, be provided internal to an inflatable tire, which may harvest power from a power source (e.g., an included battery, the external reader device electromagnetic field, or other available power source) and provide a measurement output to the user or external reader device, through a wireless or wired connection.

Since the sensor may require no internal power source such as a battery, some sensors that could be used to record measurements may be cost efficient and/or durable. In some instances, the sensor apparatus may sustain the entire life of the wheel or tire to which it is mounted. For example, by being able to quantify the efficacy of the pressure of the inflatable tire, a user may be able to know when the tire main casing or body has become ineffective at holding pressure and that it should be replaced. In some embodiments, the sensor apparatus may survive retread cycles of the tire casing, tracking the tire casing for its entire life, including one or more cycles of replacing the external tire tread.

In a wired connection, the inflatable tire or its mounting wheel can include a communication component (e.g., transceiver having a wired connection port) to allow communication to and/or from a reader. In a wireless connection, the inflatable wheel/tire assembly may include a communication component (e.g., wireless transceiver) to allow communication to and/or from reader.

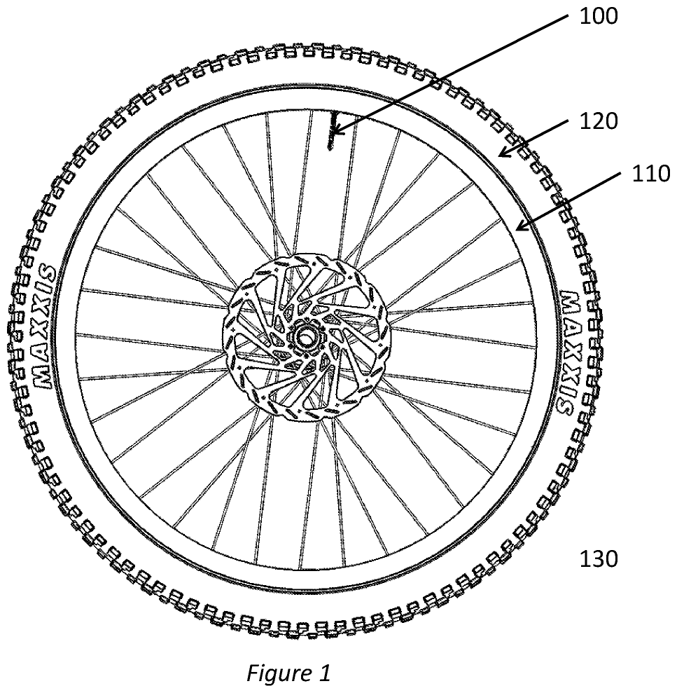

FIG. 1 illustrates a tire and wheel assembly 130. The assembly includes a tire 120 mounted to a wheel 110. The assembly also includes an air valve assembly 100 through which air may be added to the tire with a pump or removed from the dire by depressing a valve core pin. This represents a typical embodiment of a tire and wheel assembly for a bicycle. The tire may be tubeless, or there may be a separate inner tube. In the case of tubeless tires, the tire may form an airtight seal to the wheel. The seal may be enhanced or improved through the application of liquid sealants inside the tire when it is mounted to the wheel. In the case of tires with inner tubes, the inner tube provides an airtight chamber to hold the air inside, and the wheel and tire need not have an airtight seal. In the case of tires with inner tubes, the inner tube may be an integral component of the tire, or it may be separate from the tire.

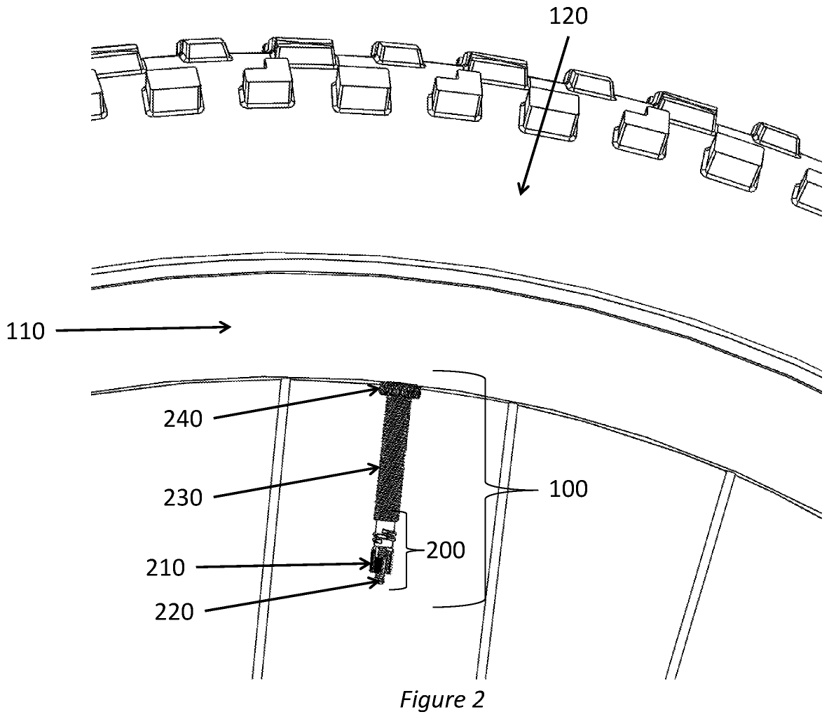

FIG. 2 illustrates a magnified portion of the valve section of the tire 120 and wheel 110 assembly. Components of the air valve assembly 100 are shown. The air valve assembly shown is known as a Presta valve type, but other valve types such as Schraeder valve types may be used in bicycle wheel and tire assemblies. The air valve assembly may be a standalone component. For example, in the case of tubeless tires, the tire is mounted to the wheel and forms an airtight seal with the wheel. The air valve assembly is a separate standalone component that also makes a seal to the wheel. Air may be added to the tubeless tire or removed from the tubeless tire through the air valve assembly. The air valve assembly may also be an integral part of a tire inner tube. In this case, the tube may contain an air valve assembly that is molded directly as part of the inner tube. The air valve assembly is pushed through a hole situated in the wheel for the air valve assembly when the inner tube is mounted to the wheel.

Some components of the Presta valve may also be seen in FIG. 2. These components may be included in the Presta air valve assembly whether it is a standalone air valve assembly or it is molded as an integral part of a tire inner tube. The valve body 230 is threaded to accept the rim nut 240. The rim nut is threaded down the valve body until it meets the wheel. In the case where the air valve assembly is a standalone component, the rim nut is tightened to secure the air valve assembly tightly to the wheel in order to make an air tight seal. In the case where the air valve assembly is an integral part of an inner tube, the rim nut is used to ensure the air valve assembly does not push too deeply into the tire. This may be especially useful when an air pump is pushed onto the Presta valve so that the pressure of pushing the pump on does not push the valve deeply into the wheel.

The valve core 200 is threaded into internal threads in the valve body 230. Air enters or leaves the tire through the valve core. The Presta valve core includes a core pin 220 and a lock nut 210. When the lock nut is tightened, the core pin may not move in the valve core, and air is not able to enter or leave the tire through the valve. In order to inflate or deflate the tire, the lock nut must be at least partially loose and the core pin must be pushed inward toward the valve body. To inflate the tire, the lock nut is loosened and a pump is pushed onto the valve core. The pump pushes down the core pin, which allows air to move through the valve core.

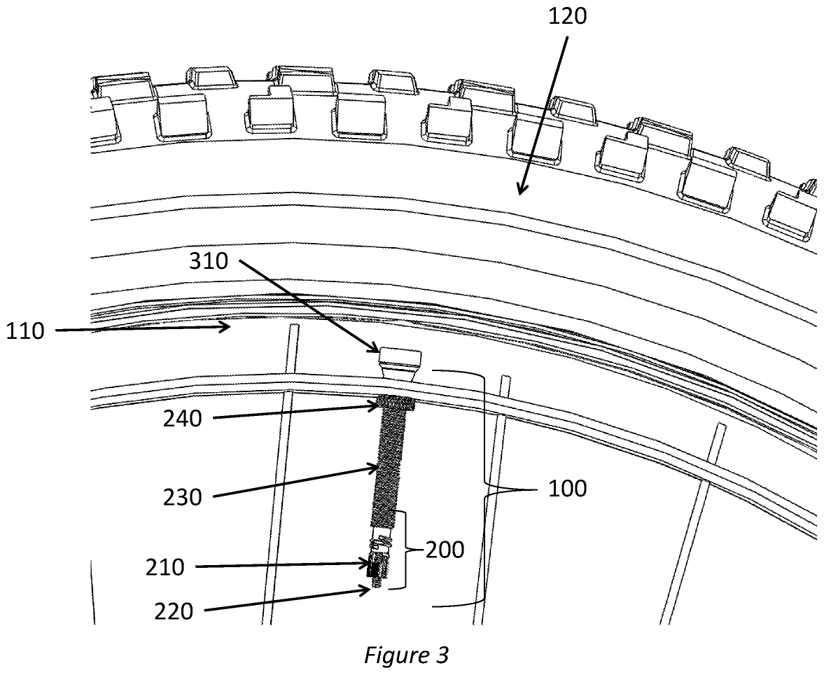

FIG. 3 is an illustration of the cross section of a bike wheel in accordance with some embodiments. The tire 120, wheel 110, and air valve assembly 100 are shown. The valve core 200, lock nut 210, core pin 220, valve body 230 and rim nut 240 serve the same purpose as described in FIG. 2. The cross section view of the wheel shows the rubber plug 310. The rubber plug may be present whether the air valve assembly is standalone or is an integral part of an inner tube. When the rim nut is tightened, it pulls the rubber plug 310 tightly into place in the air valve assembly hole in the wheel. The rubber plug is pulled tightly into place by the rim nut 240, allowing the rubber plug to make an airtight seal with the wheel. The rubber plug is especially useful on standalone valves as it may minimize or prevent air from leaking out of tubeless tires between the wheel and valve body.

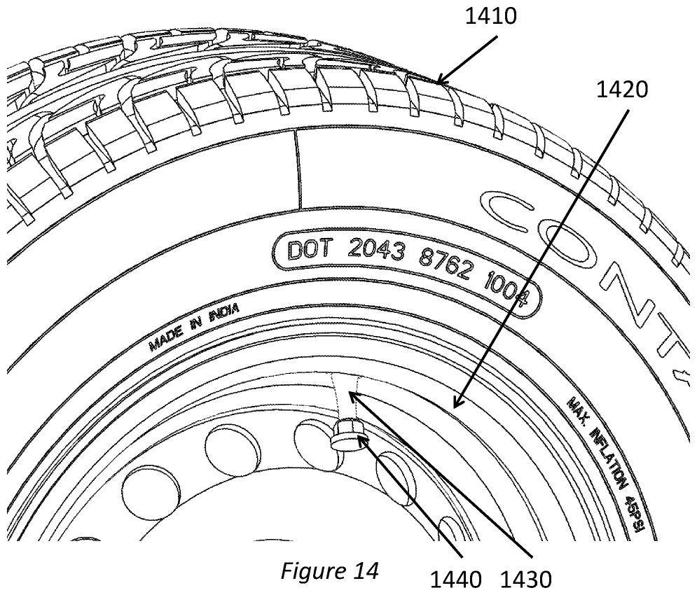

FIG. 14 illustrates a vehicle tire and wheel assembly in accordance with some embodiments. Such wheel and tire assemblies may be used in passenger cars, trucks, all-terrain vehicles (ATVs), tractors, motorcycles, and the like. The tire 1410 may be mounted to the wheel 1420, and air may be added to or removed from the tire through the air valve assembly 1430. A valve cap 1440 may be used to keep dust and debris away from the inside of the air valve assembly, potentially reducing the risk of air leakage through the valve.

The tire may be tubeless, or there may be a separate inner tube. In the case of tubeless tires, the tire may form an airtight seal to the wheel. The seal may be enhanced or improved through the application of liquid sealants inside the tire when it is mounted to the wheel. In the case of tires with inner tubes, the inner tube may provide an airtight chamber for the air in the tire, and the wheel and tire need not have an airtight seal. In the case of tires with inner tubes, the inner tube may be an integral component of the tire, or it may be separate from the tire.

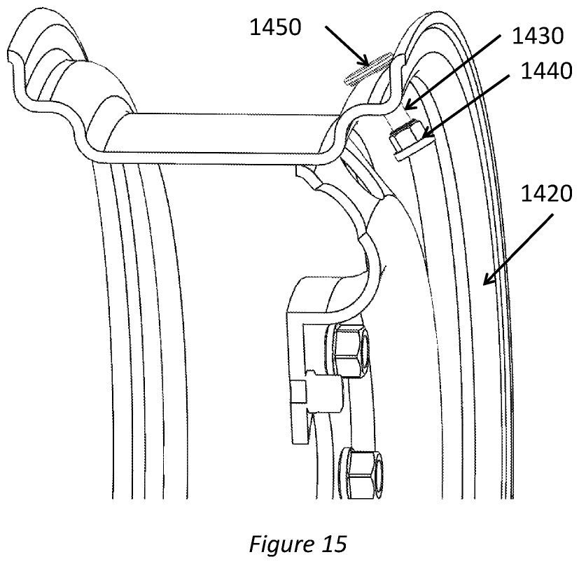

FIG. 15 illustrates a vehicle wheel cross section in accordance with some embodiments. An air valve assembly 1430 to add air to the may be mounted to the wheel. The air valve assembly may be surrounded by a soft rubberlike material to provide an airtight seal between the hole in the wheel for the air valve assembly and the air valve assembly itself. The air valve assembly may be pulled through this hole until it pops into place and forms an airtight seal. A rubber flange 1450 at the bottom may form part of the seal. The rubber flange 1450 may also provide a positive stop when the air valve assembly is pulled through the hole, preventing the air valve assembly from pulling all the way through the hole. A valve cap 1440 may keep dust, debris, and liquid out of the air valve assembly opening, maintaining good operation of the valve core inside.

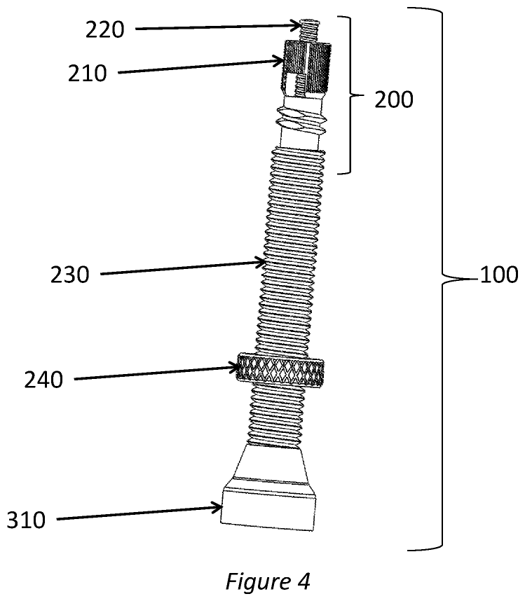

FIG. 4 illustrates a type of air valve assembly in accordance with some embodiments. The air valve assembly 100 shown in FIG. 4 is known as a Presta type valve and is often used as a valve for bicycle wheels. To mount the air valve assembly 100 to the wheel, the tire is generally removed from the wheel to allow access to the valve mounting hole. The rim nut 240 is removed from the air valve assembly, and the air valve assembly is inserted through the valve mounting hole starting from the outer radius of the wheel and pushing the air valve assembly inward toward the center of the wheel until the valve body 230 protrudes through the inside radius of the wheel. The rim nut 240 is threaded back on the valve body and tightened down to secure the air valve assembly to the wheel between the rubber plug 310 and the rim nut 240. The valve core 200 is used to add air to or remove air from the tire. To open the valve to allow air to enter or exit, the lock nut 210 is loosened, and the core pin 220 is depressed. The design of air pumps used to add air through a valve generally depress the valve core when the pump is applied to the valve.

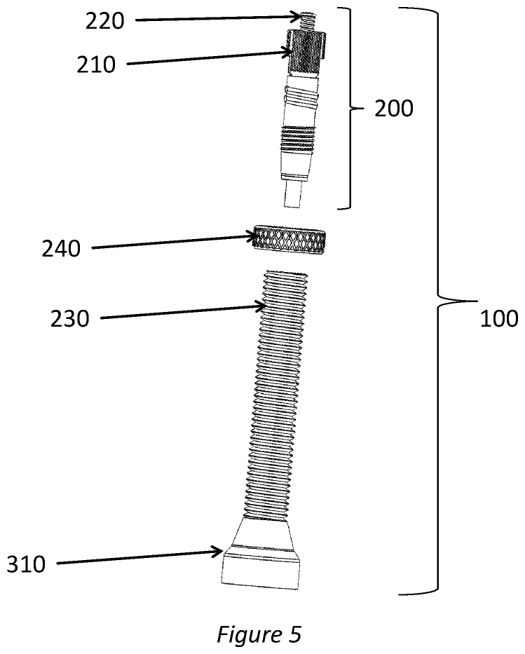

FIG. 5 illustrates a type of air valve assembly with a removable valve core assembly in accordance with some embodiments. Some valve assemblies 100 may be designed and built with the ability to remove the valve core assembly 200. In such designs, the valve core assembly may have external threads that are threaded into internal threads in the valve body 230. A valve core assembly may be removed to open a wider path for air to enter or exit the tire more quickly. If a valve core assembly is removable, it may also be replaced if it is damaged or for any other reason without requiring replacement of the entire air valve assembly.

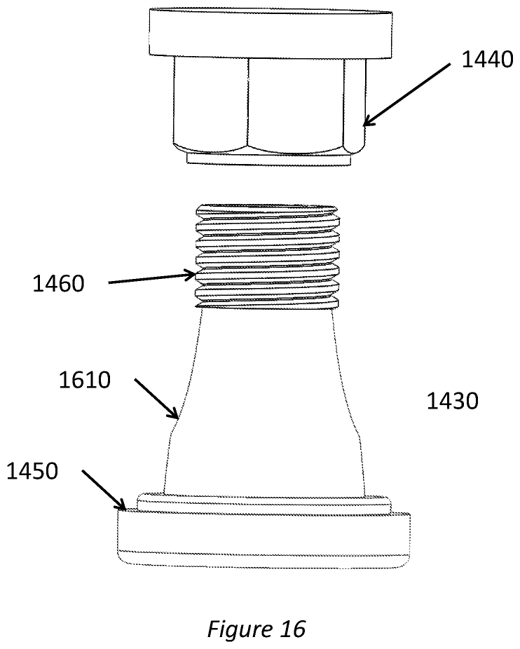

FIG. 16 illustrates a type of air valve assembly in accordance with some embodiments. The type of air valve assembly 1430 shown in FIG. 16 is known as a Schraeder type valve and is often used in passenger vehicles, trucks, ATVs, tractors, motorcycles, and bicycles. The air valve assembly may be installed in a wheel by first removing the tire and then inserting the valve through the valve hole in the wheel, inserting from the outer radius of the wheel and pushing through the valve hole to the wheel center as shown in FIG. 15. A rubber flange 1450 forms a positive stop that prevents the valve from going all the way through the valve hole. The rubber flange may also provide an airtight seal between the air valve assembly and the wheel, stopping air from leaking around the valve body 1610. The valve body 1610 may be made of rubber. A valve cap 1440 may be fitted to the valve by threading it onto valve cap threads 1460. The valve cap may keep dust and debris out of the center of the valve, improving reliability and reducing the chance that debris may cause air leakage.

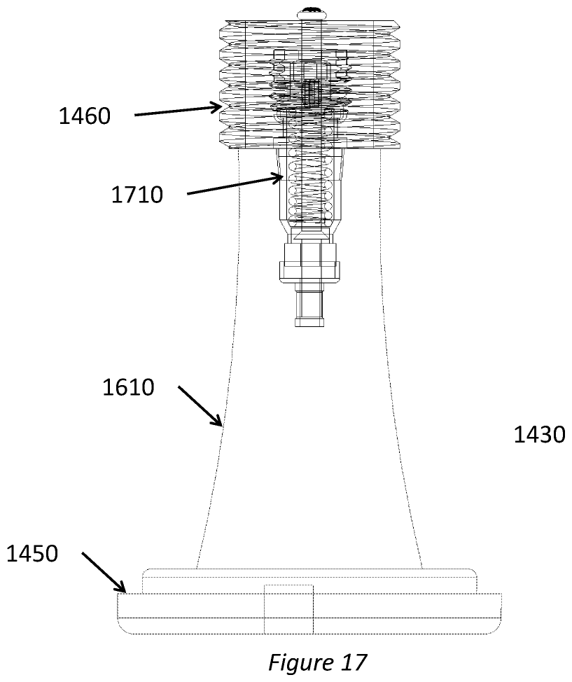

FIG. 17 illustrates a hidden line view of a type of air valve assembly in accordance with some embodiments. The type of air valve assembly 1430 shown is a Schraeder valve, variants of which are used in virtually all on-road and many off-road vehicles including semi trucks, passenger vehicles, ATVs, tractors, motorcycles, recreational vehicles, trailers, and others. The valve body 1610 is generally molded from a rubber material such as EPDM. The rubber flange 1450 is often one continuous piece of rubber with the valve body. The rubber flange 1450 and the valve body 1610 may be molded over an internal component that may include the valve cap threads 1460 and may also include interior threads for the valve core assembly 1710. The valve core assembly 1710 allows air in or out of the tire through the valve generally when a central core pin on the valve core assembly is depressed. Air pump used for these valves generally have provisions to automatically depress the central core pin to allow filling through the valve. The valve core assembly is also generally removable by unthreading it from the internal threads of the valve body. This may be done to reduce the flow restriction of having the valve core assembly installed, allowing the user to quickly inflate or deflate the tire. For example, when tires are mounted to the wheel, the tire must make a tight seal with the wheel. In order to ensure this happens, the valve core assembly is generally removed and air rapidly flows through the open valve. The tire rapidly inflates and pops onto the wheel profile seating the tire bead and providing an airtight connection between the wheel and tire.

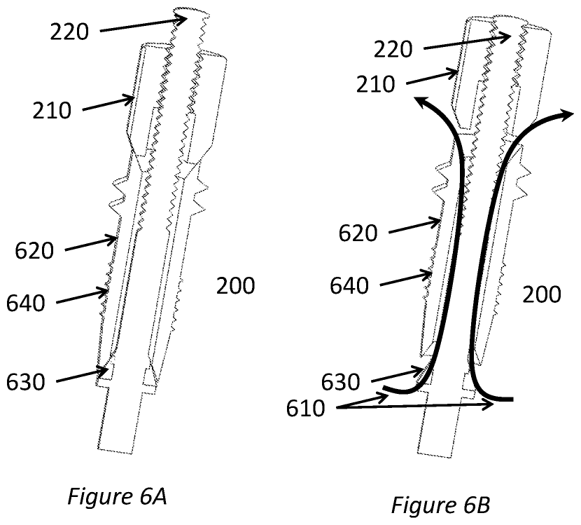

FIGS. 6A and 6B illustrate a valve core assembly in accordance with some embodiments of the present disclosure. The valve core assembly 200 shown in the figure may be referred to as a Presta-style valve core assembly. The Presta type of valve is often found on bicycles because the narrower diameter of the Presta valve body relative to the Schraeder valve body allows it to be used with narrower wheels. The valve core assembly is threaded into the Presta valve body 230 using the valve core external threads 640. These threads mate with internal threads in the valve body that accept the valve core assembly and form an airtight seal between the valve core body 620 and the valve body 230. FIG. 6A illustrates the valve core assembly when the lock nut 210 is threaded all the way on the core pin 220. In this state, the core pin is locked and it may not be depressed. The valve core pin 220 is sealed against the valve core body 620 by the core seal 630. This seal prohibits air from entering or leaving the tire through the valve core or valve body. FIG. 6B illustrates the valve core assembly when the lock nut 210 is unthreaded on the core pin 220. In this condition, the core pin may be depressed down into the valve core body 620, breaking the seal between the core pin and the valve core body. Now air may go in or out through the valve core. Air escaping 610 from the inside of the valve is shown in the figure. In this case, the pressure inside the tire is higher than the ambient pressure, so the air is escaping the tire through the valve core. To add air, a pump head is connected to the valve body and valve core, and the pump increases the air pressure on the outside of the valve core, pushing air through the valve core on the same path shown by the air escaping 610. The valve core is what generally allows the valve to allow air in or out of the tire. The other components of the valve such as the valve body simply interface to the valve core and provide an airtight seal to the valve core. Note that there are no springs in this valve core. The pressure inside the tire pushes the core pin 220 into the valve core body 620, allowing the core seal 630 to keep the air pressure inside. If the tire is at the same pressure as the ambient outside the valve core, the core pin 220 moves freely with no resistance, and there is no seal. It is only when the lock nut is threaded fully on the core pin or when there is a higher pressure inside the tire that the core seal 630 is forced into place, sealing the interior of the tire from the exterior. After the lock nut is loosened or unthreaded, the core pin still must be manually pushed down to overcome the interior pressure pushing the core pin up. This manual movement of the core pin allows air to escape the tire or to enter the tire in the case where a pump is applied.

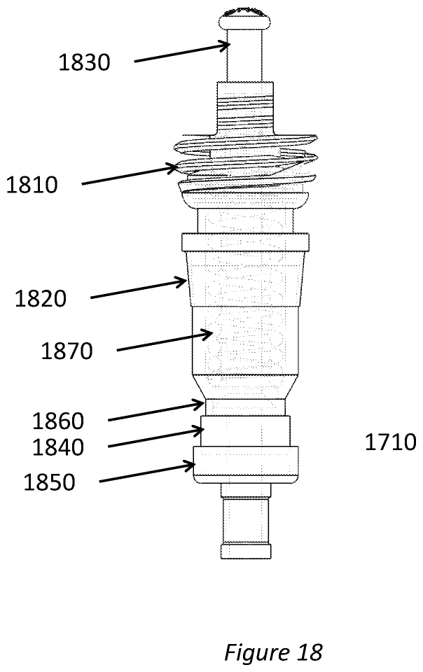

FIG. 18 illustrates a different type of valve core in accordance with an embodiment of this disclosure. The type of valve core 1710 shown may be called a Schraeder valve, which is often used in vehicles such as cars, trucks, ATVs, and the like. The operation of the valve core is similar to the valve core shown in FIGS. 6A and 6B. The core pin 1830 is connected to a valve core cap 1850. When the core pin is depressed, the valve core cap is pushed downwards, and the valve core seat 1840 moves away from the valve core seal 1860, breaking the airtight seal that had previously existed between the valve core seat and the valve core seal, and allowing air to enter or exit the tire through the valve core. Unlike the valve core in FIGS. 6A and 6B, the valve core in FIG. 18 has an internal core spring 1870 that holds the core pin in place until a downward force is applied to the core pin. The core spring pulls upward on the valve core cap 1850, maintaining the seal even if there is no air pressure inside the tire. This is unlike the valve core shown in FIGS. 6A and 6B, where there is no spring and the valve core moves freely when there is no air inside the tire. The valve core 1710 includes threads 1810 to interface with the valve body. The threads 1810 are tightened against a core outer seal 1820 that seals against the inside of the valve body when the valve core is threaded into the valve body with the threads and tightened. As in FIGS. 6A and 6B, this valve core 1710 performs all the functions necessary to allow air in or out of the tire, and the valve body simply allows the valve core to be installed and seals against the valve core.

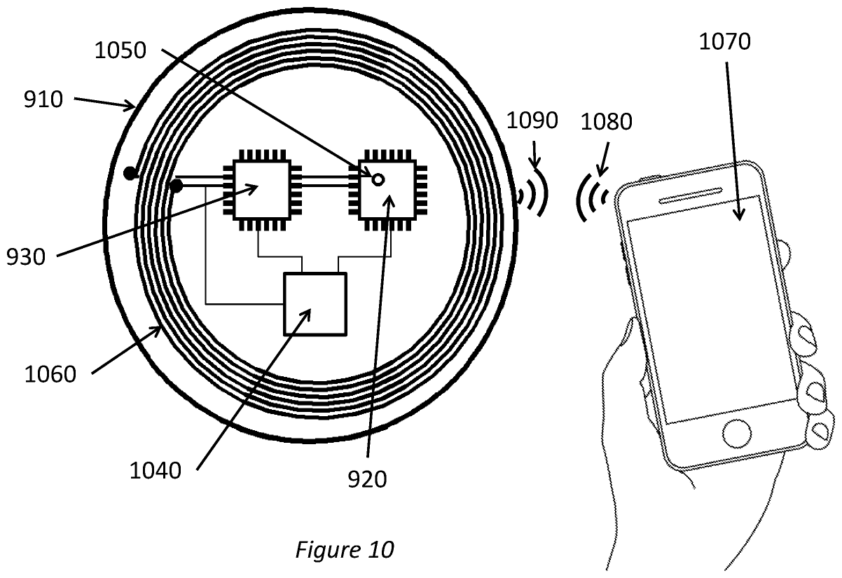

FIG. 10 illustrates a sensor apparatus in accordance with an embodiment of the current disclosure. The sensor apparatus 910 includes a number of components thereon including a sensor control circuit 930 that may communicate with the sensor transducer 920 to request and/or receive measurements. The sensor transducer 920 may measure pressure, temperature, or other parameter(s). The sensor transducer is exposed to the pressure inside the inflatable tire and converts this pressure into a sensible value, such as a voltage, or a digital data output. The sensor control circuit 930 may interpret the sensor transducer output and communicate the interpreted values to a device such as an external reader device 1070 that is outside of the inflatable tire. The external reader device may transmit an electromagnetic field 1080 to the sensor. The antenna 1060 may receive the electromagnetic field and the sensor power supply 1040 may rectify and regulate the electrical power received by the antenna from the electromagnetic field and output power to other elements of the sensor apparatus such as a sensor transducer 920 or a sensor control circuit 930. The sensor apparatus may respond to the external reader device with an electromagnetic modulation 1090 of its own. The external reader device may decode this electromagnetic modulation to obtain data from the sensor apparatus such as parameter measurements, unique identification numbers, and/or user-defined memory. The external reader device may be an NFC reader within a smartphone, a different standalone NFC reader, a UHF RFID reader, a Bluetooth communication device, or another type of wireless communication device, depending on the type of sensor apparatus electromagnetic communication protocol in use.

The sensor transducer may experience harsh environments inside a wheel or tire, including high and low temperatures, high pressures, and foreign matter such as dirt and liquids. The sensor transducer may be chosen to specifically withstand these environments. For example, in some embodiments the sensor transducer may be a pressure sensor that is gel-filled to allow full submersion in liquids. Commercially available gel-filled pressure sensor transducers exist for pressure measurement in the presence of liquids and may be used in some embodiments of the sensor apparatus. The sensor transducer may measure one or more parameters including temperature, pressure, vibration, light levels, air flow, acceleration, and rotation. The sensor transducer may measure more than one parameter and combine the results to make broader determinations or more accurate measurements. For example, since temperature may affect pressure measurement, the sensor may measure pressures and temperatures and use the data from one of these measurements to provide a higher accuracy measurement of the other. The sensor apparatus may communicate all measured parameters back to the external reader device for the user to use all measurements to interpret conditions.

In some embodiments, a tire may have tire sealant inside to stop small tire leaks. This sealant may enter the sensor transducer's air sampling port 1050 and block it from measuring the internal conditions in the tire, especially in the case of pressure measurement. To avoid this, a sensor sampling tube may be added to the sensor transducer's air sampling port that raises the pressure sampling point above the level of the sealant in the tire when the tire is at rest. The sampling tube may be a replaceable item that is serviceable on an occasional basis to replace it if it begins to become clogged with sealant or other debris.

The sensor control circuit 930 may include analog to digital conversions, communication modules, a processor and/or memory. The memory may include various types of information including unique identifier(s) enabling association of the sensor apparatus with a tire, truck, company, driver, etc, data and executable instructions for the sensor apparatus or external reader device. In some embodiments, portions of the memory may be written by the user when the sensor is installed and provisioned. In some embodiments, portions of the memory may be written wirelessly with the external reader device. User-writeable memory may be used to record things like serial numbers, tire type, company, mileage, driver name, and other parameters.

The sensor control circuit may execute instructions that are stored on an internal or external non-transitory computer device readable medium (CRM). A non-transitory CRM, as used herein, may include volatile and/or non-volatile memory.

Volatile memory may include memory that depends upon power to store information, such as various types of dynamic random access memory (DRAM), among others. Non-volatile memory may include memory that does not depend upon power to store information.

Memory and/or the processor may be located on the sensor control circuit 930 or off of the sensor control circuit, in some embodiments. In some embodiments, the sensor control circuit 930 may include a network interface. Such an interface may allow for processing executable instructions and/or data on another networked computing device, may be used to obtain information about the inflatable tires, users, or other useful information (e.g., from the manufacturer, site where inflatable tires are being used, etc.), and/or may be used to obtain data and/or executable instructions for use with various embodiments provided herein.

As discussed above, the sensor control circuit 930 may include one or more input and/or output interfaces (e.g., connection to the sensor transducer 920, connection to the power supply and communications circuits, etc.). Such interfaces may be used to connect the sensor control circuit 930 with one or more input and/or output devices.

A sensor power supply 1040 may provide power to other sensor apparatus elements. The sensor power supply may derive its power from a battery or from harvesting methods such as harvesting of an electromagnetic field emitted from the external reader device. In some embodiments, aspects the sensor power supply and the sensor control circuit may be combined. This may be useful in the case of RFID-like sensor assemblies since RFID generally harvests power and communicates responses via the same antenna. In some embodiments, the sensor control circuit 930 may communicate to the antenna through the sensor power supply circuit 1040. In other embodiments, the sensor control circuit and the power supply may each have separate connections to the antenna to harvest power and communicate with the external reader device.

The sensor apparatus 910 includes an antenna 1060. The antenna may be used to collect electromagnetic energy from the external reader device or from other nearby devices. The antenna may also be used to transmit and/or receive data to/from another device such as a sensor external reader device. Any suitable type or orientation of antenna may be used with respect to the embodiments of the present disclosure wherein the antenna may send and/or receive data and/or instructions from a remote device.

In some embodiments, the sensor apparatus and its components may be powered by a power source located within the inflatable tire (e.g., a battery as part of the sensor power supply 1040 or connected thereto). However, as indicated above, in some embodiments, the sensor may function such that a power source may be optional. That is, components of the sensor apparatus may harvest power from an external reader device or other source that is not part of the inflatable tire assembly (e.g., via antenna 1060).

Harvesting power from an external reader device may, for example, include a user approaching and/or holding the external reader device such that the external reader device may be close enough to provide adequate electromagnetic power for a sensor apparatus (e.g., pressure sensor). The external reader device may provide power to the sensor power supply 1040, which may power the entire sensor apparatus. The external reader device may then request a measurement from the sensor apparatus 910. The sensor control circuit 930 may then request a measurement from the sensor transducer 920 (e.g., requesting a pressure sensor measurement) and communicate the result via the antenna 1060. In another embodiment, the sensor control circuit may simply pass messages and measurement requests from the external reader device to the sensor transducer without the sensor control circuit creating any measurement requests of its own.

With regard to identification of the inflatable tire, in some embodiments, the sensor control circuit may include a unique identifier that may be connected to the inflatable tire and/or specific to the user for test result tracking. That is, each sensor apparatus may include a unique identifier that may be associated with a particular inflatable tire or user. In some embodiments, the sensor apparatus's unique identifier may be used as the unique identifier of the inflatable tire itself. The association between sensor apparatus identifier and inflatable tire and/or user may be stored within the sensor apparatus itself, within the external reader device, or within a database that may be internet-connected.

For example, each inflatable tire may have a different unique identifier and the identifiers may be used to identify one from another. In some embodiments, the functionality of an identifier may be provided by data stored in the sensor control circuit 930 or sensor transducer 920 and transmitted via the antenna 1060 to a remote device that is requesting the information.

In some embodiments, when the pressure test begins, the sensor can measure and/or communicate measurement (e.g. pressure or temperature) values to an external test system (e.g. an external reader device). The measurement values can include measured absolute pressure inside the inflatable tire.

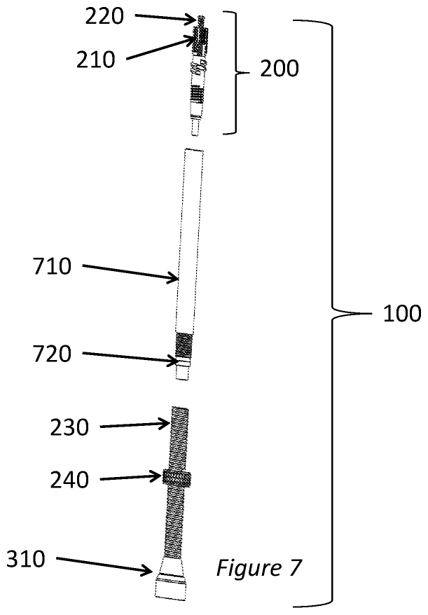

FIG. 7 illustrates an air valve assembly with an air valve extension in accordance with an embodiment of the present disclosure. The valve body 230, rim nut 240, rubber plug 310, and valve core 200 are the same as those in FIGS. 4 and 5. However, in FIG. 7, an air valve extension 710 is shown. Such air valve extensions are common in the art, and extend the valve body portion of the valve in order to allow the valve to protrude through deeper wheel cross sections. The extensions allow access to the valve core when the wheel is deeper than the valve body 230. The air valve extension simply has outer threads that match the pitch and diameter of the valve core external threads 640. These threads allow the air valve extension to thread into the same threads on the valve body that are used to accept the valve core external threads 640. An air valve extension seal 720 ensures an airtight fit between the valve body 230 and the air valve extension 710. The top portion of the air valve extension has internal threads designed to accept the valve core external threads 640. The air valve extension, then, allows the valve core to be removed from the valve body 230 and mounted back at the top of the air valve extension. The extension then may be mounted to the valve body where the core was removed. In this way, the valve body is extended by approximately the length of the air valve extension. Since the valve core is at the end of the extension farthest from the tire, the pressure inside the air valve extension is the same as the pressure inside the tire. If the pressure inside the air valve extension could be measured, it would provide an accurate measurement of the pressure inside the tire as well. The air valve extension may be a hollow tube with threads to accept the valve core and threads to thread into the valve body.

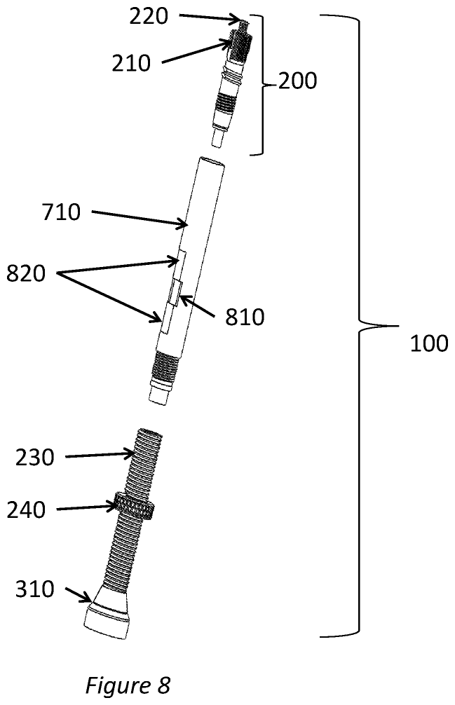

FIG. 8 illustrates an air valve assembly with an air valve extension with holes in accordance with an embodiment of the present disclosure. In this figure, the air valve extension has a through-hole 810 cut into its central body into its interior. The air valve extension also has flat portions 820 filed, machined, or cut into its surface. The air valve extension shown would not be usable as it is shown because the through-hole 810 would allow air to leak through the air valve extension. This figure illustrates an intermediate assembly in accordance with the present disclosure.

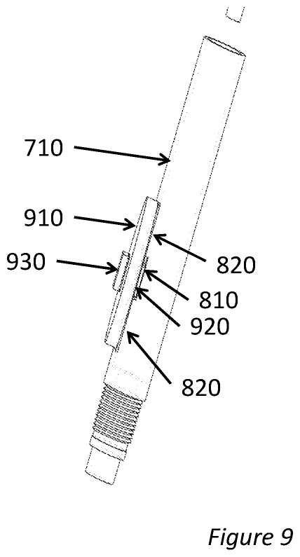

FIG. 9 illustrates an air valve extension with an integrated sensor apparatus in accordance with the present disclosure. The figure illustrates an air valve extension 710 with a through-hole 810 cut into its central body and flat portions 820 cut or filed into the body. A sensor apparatus 910 is mounted to the air valve extension. The sensor apparatus body may be adhered to the flat portions 820 in the air valve extension body. The sensor transducer 920 may access the pressure inside the air valve extension through the through-hole cut into the air valve extension body. The sensor control circuit 930 may be mounted to the sensor apparatus body. In the case of FIG. 9, the sensor control circuit is mounted on the opposite side of the sensor apparatus as the sensor transducer. This mounting may help ensure the sensor control circuit 930 does not interfere with the body of the air valve extension 710. Since the sensor transducer 920 may access the pressure inside the air valve extension through the through-hole 810, it may measure the pressure inside the air valve extension. If the air valve extension contains metal, it may interfere with the antenna 1060 of the sensor apparatus. In order to transfer power and communications, antennas for wireless protocols such as Near Field Communication or NFC may require isolation from conductive materials such as aluminum, steel, or carbon fiber. This isolation can be achieved by applying a radio frequency (RF) absorber material between the sensor antenna and the air valve extension. The RF absorber may be made of materials such as ferrite that effectively steers the electromagnetic field away from the conductive material, allowing more efficient power transfer and communication. The antenna may also be spaced away from the conductive materials by insulating materials such as fiberglass, wood, or cardboard. The disadvantage of insulating materials relative to RF absorbers is that a greater distance spacing between the antenna and the conductive object may be required to achieve efficient power transfer and communication. As mentioned previously, the pressure inside the air valve extension is the same as the pressure inside the tire. Therefore, the sensor transducer and sensor apparatus are capable of measuring the tire pressure as shown in this embodiment. In FIG. 8, the sensor apparatus is not yet sealed to the air valve extension, so air would still be able to leak through the through hole. This figure represents an intermediate assembly in accordance with the present disclosure.

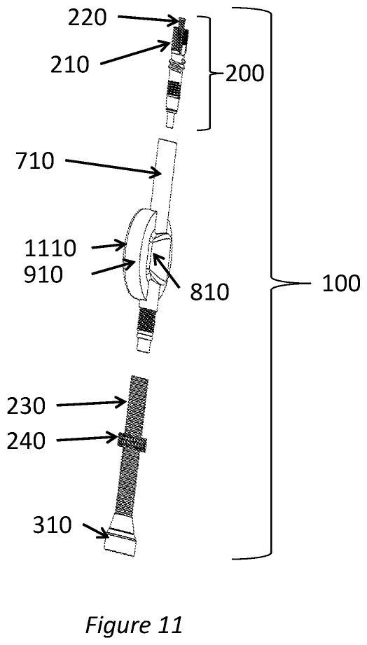

FIG. 11 illustrates an air valve assembly with an air valve extension that includes an integrated sensor apparatus that has a plastic housing surrounding it in accordance with an embodiment of the present disclosure. Again, the air valve extension 710 threads into the valve body 230, and the valve core 200 threads into the air valve extension. The air valve extension may have a hole cut into it for a sensor transducer 920 to access the pressure inside the air valve extension, which is the same as the pressure inside the tire to which the air valve assembly is coupled. Since the sensor apparatus in FIG. 8 was not sealed to the air valve extension, air could leak through the through-hole 810 in the air valve extension. In FIG. 11, a plastic housing 1110 is molded over the sensor apparatus and the air valve extension 710. The sensor apparatus and the air valve extension are thereby sealed together with the plastic housing so air cannot escape the through hole cut in the air valve extension. The sensor apparatus may be powered and/or communicate wirelessly through the plastic housing by radio frequency, RFID, optical, or other means. Alternatively, electrical contacts on the sensor apparatus may be left exposed for wired communication and/or power through these electrical contacts. FIG. 11 shows a final assembly that allows measurement of parameters inside the tire via an air valve extension with integrated sensor apparatus and plastic housing. The air valve extension and sensor apparatus may have the plastic housing insert molded over them. That is, the air valve extension and sensor apparatus may be placed inside an injection mold and molten plastic may be molded directly over the sensor apparatus and air valve extension, sealing them together and mechanically bonding them together as the plastic is molded and cools.

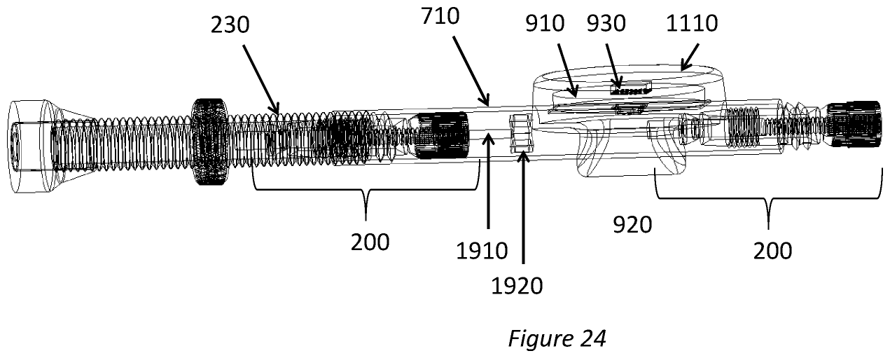

FIG. 24 illustrates an air valve assembly with air valve extension with integrated sensor apparatus and two valve cores in accordance with an embodiment of the current disclosure. Although some previous embodiments have discussed removing the valve core 200 from the valve body 230 and remounting it at the top of the air valve extension 710, it is also possible for the air valve extension 710 to have a feature in it such as a core pin depressor 1910 that depresses the first valve core 200 that is mounted to the valve body 230. The air pressure in the tire equalizes with the air pressure in the air valve extension through airways 1920 in the air valve extension that allow air to easily pass the core pin depressor. The air valve extension 710 may have an integrated sensor apparatus 910 and a plastic housing 1110 surrounding the sensor apparatus. The core pin depressor 1910 may push the first valve core pin 220, allowing pressure to exit the first valve core and enter the air valve extension. A second valve core 200 at the opposite end of the air valve extension may be used to ensure the pressure does not leave the tire completely when the first valve core pin is depressed. The second valve core also allows air to be added or removed from the tire through the air valve extension. Since the core pin depressor may depress any core that has an unlocked lock nut 210, the air valve extension with sensor apparatus shown in FIG. 24 may be used on any Presta-type valve, including those that do not have removable valve cores. Some tire inner tubes and valve assemblies do not have removable cores, eliminating the ability to remove the core from the valve body and mount it at the far end of the air valve extension. The air valve extension with sensor apparatus shown in FIG. 24 also allows installation without completely deflating the tire, since the first valve core does not need to be removed to install the air valve extension. This simplified installation may be desirable. Since the air valve extension shown in FIG. 24 mounts to the external threads of the valve body, it may be necessary to provide additional air sealing between the external threads of the valve body 230 and the mating internal threads of the air valve extension. This may be done with a sealant such as Teflon tape. Sealing may also be provided with an integrated rubber seal inside the air valve extension. In the event that the user can remove the first valve core from the air valve assembly, the air valve extension shown in FIG. 24 will continue to operate the same as it did with the first valve core assembly in place. In this case, the core pin depressor will not serve any purpose because there will be no first valve core to depress. The pressure will still fill the air valve extension and the second valve core assembly will prevent the air from leaking out of the air valve extension, and the sensor apparatus will still be able to measure the pressure inside the air valve extension, which will still be equal to the pressure inside the tire.

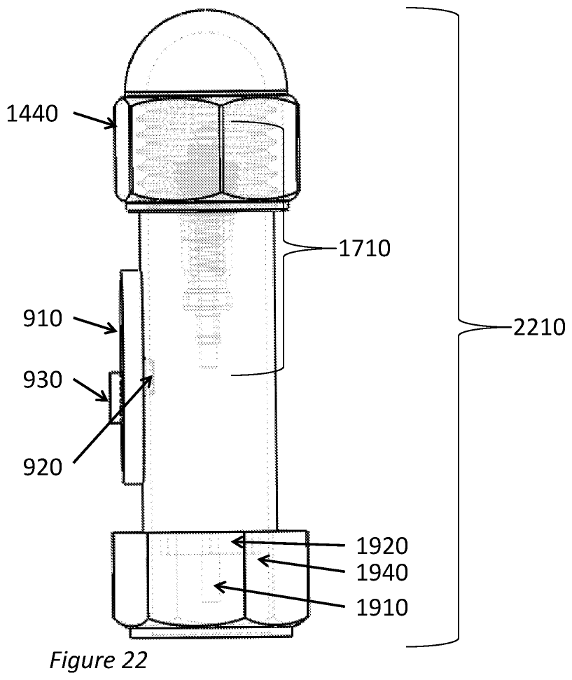

FIG. 22 illustrates an air valve extension with integrated sensor apparatus in accordance with an embodiment of the present disclosure. The air valve extension 2210 shown in FIG. 22 is a Schraeder type valve like those used on cars and trucks. The sensor apparatus 910 is mounted to the air valve extension 2210 and includes a sensor transducer 920 that may access the pressure inside the air valve extension through a through-hole cut or machined in the side of the air valve extension. The air valve extension threads onto a Schraeder valve and a core pin depressor 1910 may depress the core pin of the Schraeder valve core to which the air valve extension is mounted. In this way, the pressure inside the tire and inside the Schraeder valve can reach the inside of the air valve extension 2210 and be measured by the sensor apparatus 910. A second valve core 1710 is mounted to the air valve extension to allow air to be added or removed through the air valve extension 2210. A face seal 1940 may form an airtight seal between the air valve extension and the Schraeder valve to which it is mounted. Airways 1920 may allow air to pass the core pin depressor 1910, allowing the pressure inside the air valve extension to equalize with the pressure inside the Schraeder valve to which it is mounted and the tire to which the Schraeder valve is coupled. A Schraeder valve cap 1440 may be threaded onto the air valve extension threads to protect the valve core 1710 from dust and debris.

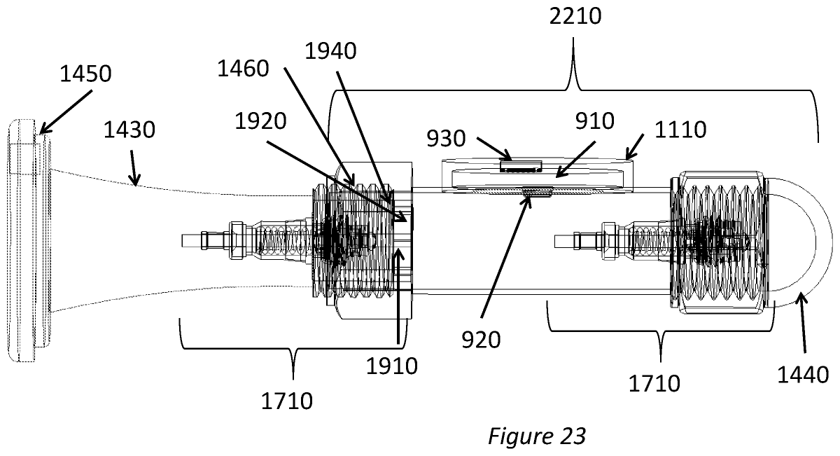

FIG. 23 illustrates an air valve extension with integrated sensor apparatus coupled to a Schraeder air valve assembly in accordance with an embodiment of the present disclosure. The figure illustrates an air valve extension 2210 with a core pin depressor 1910 that is attached to a Schraeder air valve assembly 1430 by threading it onto the air valve assembly cap threads 1460. The air valve assembly includes a first valve core 1710 that is installed in the air valve assembly. The core pin of this first valve core may be depressed by the core pin depressor 1910 in the air valve extension 2210. Airways 1920 in the air valve extension allow air to pass the core pin depressor such that the pressure inside the air valve extension is equal to the pressure inside the tire. A second valve core assembly 1710 at the opposite end of the air valve extension seals the air valve extension airway to contain the air pressure in the tire. A pump may be connected to this end of the air valve extension to add or remove air from the tire through the second valve core assembly. A valve cap 1440 may be fitted to the threads at the end of the air valve extension 2210 to protect the second valve core assembly from dust and debris. A sensor apparatus 910 is mounted to the air valve extension and a sensor transducer 920 may access the pressure inside the air valve extension, which is equal to the pressure inside the tire. By measuring the pressure inside the air valve extension, the sensor transducer may thereby measure the pressure inside the tire. The sensor apparatus includes a sensor control circuit 930 that allows communication between the sensor transducer and an external reader device. The sensor apparatus is housed in a plastic housing 1110 that mechanically attaches the sensor apparatus to the air valve extension and also seals the sensor apparatus to the air valve extension, reducing or eliminating air leakage through a through-hole in the air valve extension through which the sensor transducer accesses the pressure in the air valve extension. In the event that the user can remove the first valve core from the air valve assembly, the air valve extension shown in FIG. 23 will continue to operate the same. In this case, the core pin depressor will not serve any purpose because there will be no first valve core to depress. The pressure will still fill the air valve extension and the second valve core assembly will prevent the air from leaking out of the air valve extension, and the sensor apparatus will still be able to measure the pressure inside the air valve extension, which will still be equal to the pressure inside the tire.

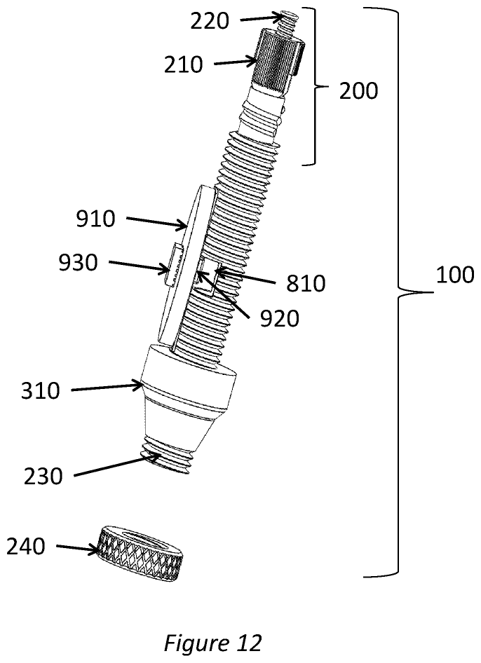

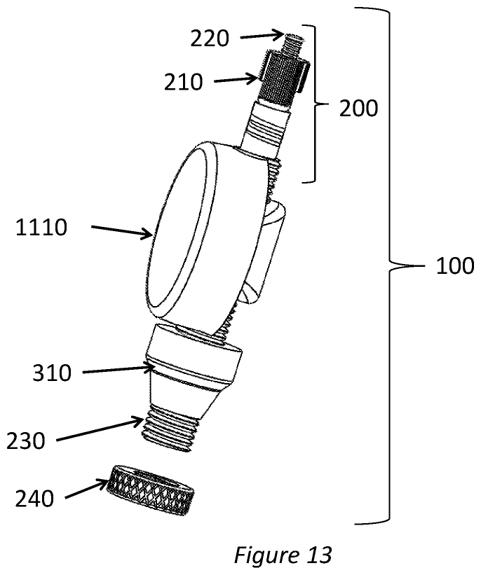

FIG. 12 illustrates an air valve assembly with an integrated sensor apparatus in accordance with an embodiment of the present disclosure. The valve body 230 of the air valve assembly 100 includes a through-hole 810 such that a sensor transducer 920 portion of a sensor apparatus 910 may access the pressure inside the valve, which is equal to the pressure inside the tire. By measuring the pressure inside the valve the sensor transducer is able to measure the pressure inside the tire. The air valve assembly still includes a rubber cone 310, but since the sensor apparatus may be unable to fit through the hole for the valve body 230 that is in the wheel, the valve body may be fed through the wheel in the opposite direction. The valve body may go through the hole in the wheel from the inner radius and the rim nut 240 may be attached to the valve body from inside of the wheel. The rim nut may be tightened to the valve body inside the wheel before the tire is mounted to the wheel. The rubber cone 310 may be drawn tightly into the hole in the wheel using the rim nut, and the rubber cone may seal the junction between the valve body and the wheel from air leakage around the hole in the wheel. It may be possible to develop a sensor apparatus that could fit through the hole in the wheel, or the sensor apparatus may be foldable or bendable to fit through the hole in the wheel. A rim nut designed in two pieces may allow the rubber cone to be mounted inside the wheel and the rim nut would be attached to the body below the sensor assembly. A valve core assembly 200 prevents air leakage from the air valve assembly, and also allows air to be added to or removed from the tire. If the air valve assembly contains metal, it may interfere with the antenna 1060 of the sensor apparatus. In order to transfer power and communications, antennas for wireless protocols such as Near Field Communication or NFC may require isolation from conductive materials such as aluminum, steel, or carbon fiber. This isolation can be achieved by applying a radio frequency (RF) absorber material between the sensor antenna and the air valve assembly. The RF absorber may be made of materials such as ferrite that effectively steers the electromagnetic field away from the conductive material, allowing more efficient power transfer and communication. The antenna may also be spaced away from the conductive materials by insulating materials such as fiberglass, wood, or cardboard. The disadvantage of insulating materials relative to RF absorbers is that a greater distance spacing between the antenna and the conductive object may be required to achieve efficient power transfer and communication. The air valve assembly shown in FIG. 12 illustrates an intermediate design, and leakage through the through-hole 810 requires sealing as described in FIG. 13.

FIG. 13 illustrates an air valve assembly with integrated sensor apparatus and plastic housing in accordance with an embodiment of the present disclosure. The air valve assembly 100 in FIG. 12 would leak air through the through hole in the valve body. The air valve assembly 100 in FIG. 13 adds a plastic housing 1110 over the sensor apparatus 910 which seals the sensor apparatus 910 to the valve body 230, preventing air leakage. The plastic housing 1110 may be insert-molded over the sensor apparatus and valve body. That is, the valve body and sensor apparatus may be inserted into an injection mold and molten plastic may be molded over the sensor apparatus and valve body. When the plastic solidifies into a plastic housing, it may then form a mechanical bond between the sensor apparatus and valve body. The plastic housing may also prevent air leakage from the through-hole 810 in the valve body. The rubber cone 310 is inverted in direction from a valve body that mounts from the outer radius of the wheel. Typically, an air valve assembly is inserted from the tire side (the outer radius) of the wheel. However, since the integrated sensor apparatus may not be able to fit through the air valve assembly hole in the wheel, the air valve assembly shown in FIG. 13 feeds from the non-tire side (the inner radius) of the wheel, and the rubber cone is integrated to the valve body and feeds from the non-tire side as well. The rim nut 240 is mounted from the tire side of the wheel when the tire is off, and is tightened to draw the rubber cone 310 into the air valve assembly hole in the wheel in order to seal between the valve body and the air valve assembly hole in the wheel.

FIG. 21 illustrates an air valve assembly with integrated sensor apparatus in accordance with an embodiment of the present disclosure. The air valve assembly 1430 shown is a Schraeder air valve assembly with an overmold flange 1450. The valve body and overmold flange are molded from rubber. A sensor transducer 920 may reside inside the valve body or on the overmold flange as shown, where it may access the pressure inside the tire. The sensor transducer will be able to measure a pressure inside the tire and it may communicate the measured pressure along wires 2110 to the sensor apparatus 910 with sensor control circuit 930. The resultant pressure may be read from the sensor apparatus with an external reader device. The wires and sensor transducer may be partially molded inside the rubber body of the air valve assembly. The sensor transducer may be adhered to the sensor assembly body or the overmold flange with adhesive. The sensor transducer may be adhered to the wires that connect it to the sensor apparatus and sensor control circuit. The wires may be pushed through the air valve assembly body.

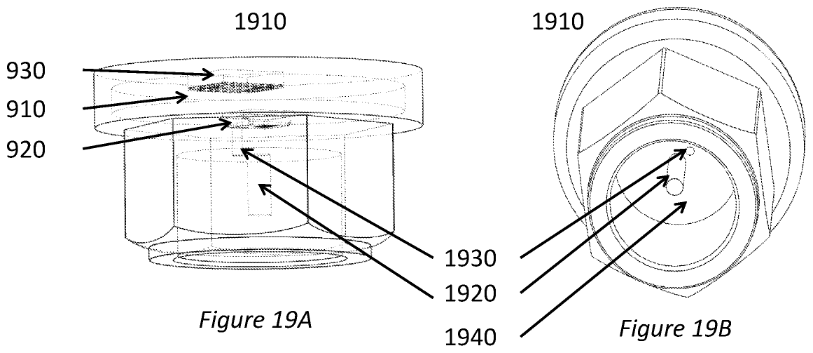

FIGS. 19A and 19B illustrate a valve cap with integrated sensor apparatus in accordance with an embodiment of the present disclosure. The valve cap 1910 may be mounted to the cap threads 1460 illustrated in other figures. The valve cap may include a core pin depressor 1920 capable of pushing down the core pin on the valve to which the valve cap is mounted such that the valve core assembly is opened to allow the air pressure to equalize between the interior of the valve cap and the interior of the tire. A pressure access hole 1930 may allow a sensor transducer 920 to access the pressure inside the valve cap. Since the core pin depressor has equalized the pressure inside the valve cap with the pressure inside the tire, when the sensor transducer measures the pressure inside the valve cap interior, it is equal to the pressure inside the tire. Therefore, by measuring the valve cap interior pressure, the sensor transducer measures the pressure inside the tire. A face seal 1940 may seal the outer edge of the cap threads 1460 to the interior of the valve cap such that air leakage from the valve cap is minimized. The sensor apparatus 910 may include a control circuit to control measurements from the sensor transducer 920 and to communicate with the external reader device.

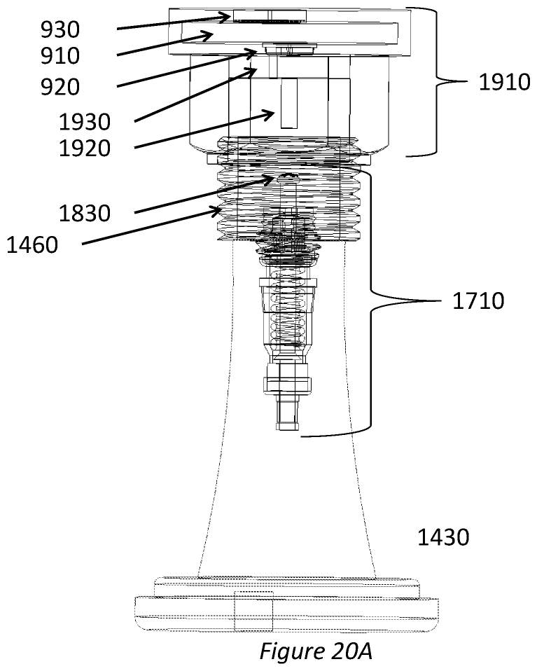

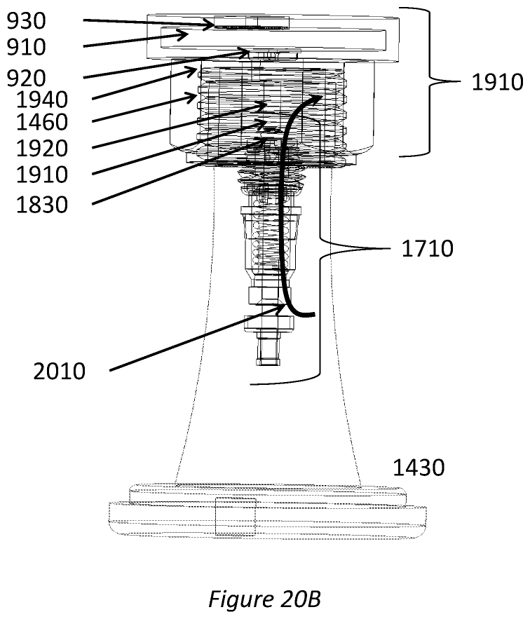

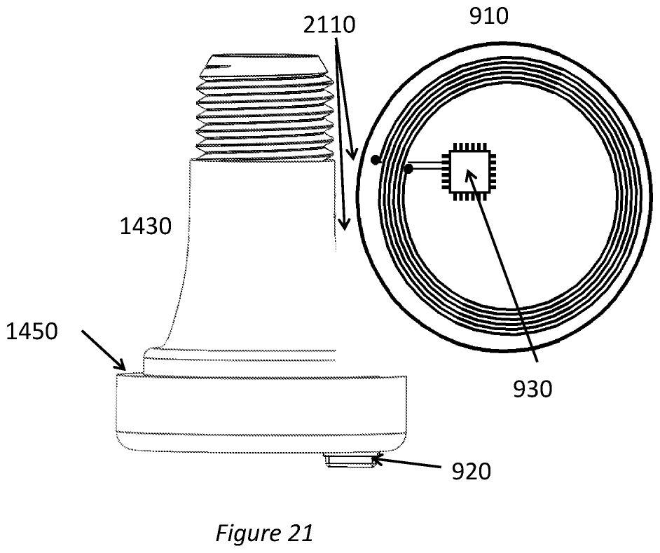

FIGS. 20A and 20B illustrate a valve cap with integrated sensor apparatus mated to an air valve assembly in accordance with an embodiment of the present disclosure. In FIG. 20A, the valve cap 1910 begins to be threaded onto the valve cap threads 1460. However, the core pin depressor 1920 has not yet made contact with the valve core pin 1830. Therefore, the pressure in the interior of the valve cap has not yet equalized with the pressure inside the tire, and the sensor apparatus 910 is unable to measure the pressure inside the tire. In FIG. 20B, the valve cap 1910 has completely threaded onto the valve cap threads 1460, so the core pin depressor 1910 has depressed the core pin 1830 adequately to open the valve core assembly, allowing air 2010 to flow from the inside of the air valve assembly to the inside of the valve cap. This enables the pressure inside the valve cap to equalize with the pressure inside the tire. The sensor transducer 920 may measure the pressure inside the valve cap through the pressure access hole 1920, and the sensor apparatus 910 may obtain the pressure information from the sensor transducer 920 and communicate it to an external reader device via the sensor control circuit 930. The face seal 1940 may make an airtight seal with the top of the valve cap threads 1460 to ensure that air does not leak out of the valve cap.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above values and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A sensor apparatus coupled to a tire and wheel assembly with internal air pressure; the sensor apparatus comprising:
A sensor transducer with access to pressure inside the tire and wheel assembly, measuring parameters of the tire and wheel assembly
An antenna that wirelessly communicates to a reader device (e.g. a smartphone) external to the tire and wheel assembly
A sensor control circuit configured to interpret queries from the reader device, communicate with the sensor transducer, and respond to the reader device with data from the sensor transducer,
Where the sensor apparatus is coupled to an air valve assembly (e.g. comprising an air valve, air valve extension and valve cap) that maintains the pressure inside the tire and wheel assembly, and
Where the sensor apparatus obtains all necessary energy for measurement and communication from the reader device via the near-field communication (NFC) protocol.

2. The sensor apparatus described in claim 1 where the sensor apparatus is coupled to the body of the air valve that maintains the pressure inside the tire and wheel assembly

3. The sensor apparatus described in claim 2 where a plastic or rubber material is molded over the sensor apparatus and the air valve to provide mechanical coupling of the components and/or to form an air-tight seal.

4. The sensor apparatus described in claim 1 where the sensor apparatus is coupled to the air valve extension that is coupled to the air valve that maintains the pressure inside the tire and wheel assembly

5. The sensor apparatus described in claim 4 where a plastic or rubber material is molded over the sensor apparatus and the air valve extension to provide mechanical coupling of the components and/or to form an air-tight seal.

6. The sensor apparatus described in claim 1 where the sensor apparatus is coupled to a valve cap that is coupled to the air valve or the air valve extension that maintains the pressure inside the tire and wheel assembly

7. The sensor apparatus described in claim 6 where a plastic or rubber material is molded over the sensor apparatus and the valve cap to provide mechanical coupling of the components and/or to form an air-tight seal.

8. The sensor apparatus described in claim 1 where a gas pressure is measured by the sensor transducer.

9. The sensor apparatus described in claim 1 wherein the sensor apparatus includes a unique identification code.

10. The sensor apparatus described in claim 1 wherein the reader device is further configured to obtain an external ambient pressure outside of the tire to provide a gauge pressure reading.

11. A system for measuring parameters inside a tire, comprising:
a tire and wheel assembly with an air valve assembly that maintains a gas pressure; and
a sensor apparatus coupled to the air valve assembly for measuring parameters within the tire and wheel assembly; and
a reader device (e.g. a smartphone) external to the tire and wheel assembly that communicates with the sensor apparatus; where
the sensor apparatus obtains all energy necessary for communication and measurement from the reader device via the near-field communication (NFC) protocol.

12. The system of claim 11, wherein the sensor apparatus measures a gas pressure within the tire and wheel assembly.

13. The system of claim 11, wherein the sensor apparatus is coupled to an air valve extension that is coupled to the air valve assembly.

14. The system of claim 11 wherein the sensor apparatus is coupled to a valve cap that is coupled to the air valve assembly.

15. The system of claim 11, wherein the sensor apparatus obtains all required power for measurement and communication from the external reader device.

16. A method for testing a pressure, comprising:
a tire and wheel assembly;
a sensor apparatus;
an air valve assembly
measuring parameters within the tire and wheel assembly using the sensor apparatus; and
wirelessly communicating these measured parameters to an external reader device (e.g. a smartphone) to notify the user of pressure conditions inside the tire and wheel assembly; where
the sensor apparatus obtains all energy necessary for communication and measurement from the external reader device via the near-field communication (NFC) protocol.

17. The method of claim 16, wherein the sensor apparatus is coupled to the air valve assembly.

18. The method of claim 16, wherein the sensor apparatus is coupled to an air valve extension that is coupled to the air valve assembly.

19. The method of claim 16, further comprising identifying a particular tire and wheel assembly using a unique identifier within the sensor apparatus.

20. The method of claim 16, wherein the external reader device provides power for the sensor apparatus to measure parameters and communicate results.
